(19) United States
(12) Patent Application Publication
(10) Pub. No.: US 2026/0106085 A1
(43) Pub. Date: Apr. 16, 2026

(54) SOLID ELECTROLYTIC CAPACITOR AND METHOD FOR PRODUCING SAME

(71) Applicant: NIPPON CHEMI-CON CORPORATION, Osaki, Shinagawa-ku, Tokyo (JP)

(72) Inventors: Wataru INOUE, Osaki, Shinagawa-ku, Tokyo (JP); Yuki OSUGA, Osaki, Shinagawa-ku, Tokyo (JP); Nodoka MURAKOSHI, Osaki, Shinagawa-ku, Tokyo (JP)

(21) Appl. No.: 19/117,148

(22) PCT Filed: Sep. 8, 2023
(86) PCT No.: PCT/JP2023/032911

§ 371 Date: Mar. 31, 2025

(30) Foreign Application Priority Data
Sep. 30, 2022 (JP) 2022-158873

(51) Int. Cl. H01G 9/00; H01G 9/048

(52) U.S. Cl. CPC H01G 9/0036; H01G 9/048

(57) ABSTRACT

The present disclosure provides a manufacturing method to improve a capacity appearance rate of a solid electrolytic capacitor, and a solid electrolytic capacitor with improved capacity appearance rate. A wound body 1, in which anode foil on which dielectric oxide film is formed and cathode foil facing each other are wound, is wrapped by a hydrophobic adhesive tape 2. Lead terminals 3 having a lead wire 31, a round bar portion 32, and a flat portion in series are connected to the anode foil and the cathode foil at the flat portion 33. The wound body 1 is immersed in conductive polymer solution at least at half a height or higher of the round bar portion 32 or 1 mm or higher from one end surface 1a of the wound body 1. And conductive polymer is attached to at least at half a height or higher of the round bar portion 32 or 1 mm or higher from one end surface 1a of the wound body 1.

### CROSS REFERENCE TO RELATED APPLICATION

This patent application is a national stage application of International Patent Application No. PCT/JP2023/032911, filed on Sep. 8, 2023, which claims priority to Japanese Patent Application No. 2022-158873 filed with the Japanese Patent Office (JPO) on Sep. 30, 2022. The disclosures of the two applications each are incorporated herein by reference in its entirety.

### FIELD OF INVENTION

The present disclosure relates to a wound-type solid electrolytic capacitor including conductive polymers as an electrolyte, and a manufacturing method thereof.

### BACKGROUND

Electrolytic capacitors include valve action metal, such as tantalum or aluminum, as anode foil and cathode foil. A surface of the anode foil is enlarged by making the valve action metal into a sintered body or a shape such as etching foil, and the enlarged surface has a dielectric film layer thereon. An electrolyte intervenes between the anode foil and the cathode foil. The electrolyte closely contacts the uneven surface of the anode foil and acts as a true cathode.

A wound-type is known as a form of the electrolytic capacitor. A wound-type electrolytic capacitor includes anode foil, cathode foil, and a separator. The anode foil and the cathode foil are a strip-shaped foil body. The cathode foil and the anode foil face each other via the separator. Then, the strip-width direction and the winding axis are matched, and the foil are wound so that the strip-longitudinal direction thereof is rounded. A strip of an adhesive tape is wrapped on the outer circumference of the wound body so as to prevent the wound body from unraveling (refer Patent Document 1: JP H01-201911A).

In recent years, solid electrolytic capacitors, in which conductive polymers are filled in the wound body as the electrolyte, are rapidly becoming popular. The conductive polymer is derived from monomers having π-conjugated double bonds. For example, the conductive polymer may be poly(3,4-ethylenedioxythiophene) (PEDOT) which excellently adheres to the dielectric film. For the conductive polymer, at the time of chemical oxidative polymerization or electrolytic oxidative polymerization, polyanions, such as organic sulfonic acid, are used as the dopant, exhibiting high conductivity.

In addition to low equivalent series resistance, the solid electrolytic capacitor is also advantageous in that there is no risk for dry-up due to evaporation and volatilization of the electrolytic solution outside over time, exhibiting long lifetime. However, in order to give the defect repairing action of the dielectric film and reduce the leakage current of the solid electrolytic capacitor, a so-called hybrid-type solid electrolytic capacitor using the conductive polymer and the electrolytic solution is getting common (for example, refer Patent Document 2: JP2006-114540A).

### SUMMARY OF INVENTION

### Problems to be Solved by Invention

The conductive polymer is attached in the wound body by immersing the wound body in conductive polymer solution. The conductive polymer solution has water as the main solvent and is dispersion or solution in which the conductive polymer is dispersed or dissolved in water. Compared to electropolymerization and oxidative polymerization immersing the wound body in the polymerization solution, the method of impregnating the conductive polymer solution does not expose the wound body in the high temperature and does not leave impurities in the wound body.

However, the adhesive tape used for wrapping the outer circumference of the wound body has a hydrophobic substrate such as polypropylene because water is generally used in the manufacturing process of the solid electrolytic capacitor. The hydrophobic adhesive tape repels the conductive polymer solution and prevents the conductive polymer solution from penetrating in the wound body. Therefore, there is a room for improving the properties of the solid electrolytic capacitor, such as further improving the adhesion of the conductive polymer and the dielectric film and improving the capacitance of the solid electrolytic capacitor.

The present disclosure has been proposed to address the above problems, and an objective is to provide a manufacturing method to improve the capacity appearance rate of the solid electrolytic capacitor, and a solid electrolytic capacitor with improved capacity appearance rate.

### Means to Solve the Problem

To address the above problems, a manufacturing method of a solid electrolytic capacitor of the present embodiment includes: a winding process of winding anode foil on which dielectric film is formed and cathode foil facing each other to form a wound body; a wrapping process of wrapping a hydrophobic adhesive tape around a circumferential surface of the wound body; and a solid electrolyte formation process of attaching a conductive polymer in the wound body by immersing the wound body wrapped by the adhesive tape in conductive polymer solution, in which the conductive polymer is dispersed or dissolved, in which a lead terminal has a flat portion, a round bar portion, and a lead wire in series, the flat portion is connected to the anode foil and the cathode foil at the flat portion, the round bar portion protrudes from one end surface of the wound body, the lead wire is drawn out from one end surface of the wound body, and in the solid electrolytic formation process, the wound body is immersed in the conductive polymer solution at least at half a height or higher of the round bar portion or at 1 mm or higher from one end surface of the wound body.

To address the above problems, a solid electrolytic capacitor of the present embodiment includes: a wound body which is anode foil on which dielectric film is formed and cathode foil facing each other and wound; an adhesive tape which intervenes between the anode foil and the cathode foil in the wound body and which is hydrophobic and wrapped around a circumferential surface of the wound body; a lead terminal having a flat portion, a round bar portion, and a lead wire in series, the flat portion connected to the anode foil and the cathode foil, the round bar portion protruding from one end surface of the wound body, and the lead wire drawn out from one end surface of the wound body; and a conductive polymer attached to at least at half a height or higher of the round bar portion or 1 mm or higher from one end surface of the wound body.

In the winding process, a separator with air permeability of 5.5 [s/100 mL] or less may be intervened between the anode foil and the cathode foil and wound. The wound body may include a separator with air permeability of 5.5 [s/100 mL] or less intervening between the anode foil and the cathode foil.

The conductive polymer solution may have viscosity of 10 mPa·s to 60 mPa·s. The conductive polymer solution may contain water as a solvent. The conductive polymer may be formed using the conductive polymer solution containing water as a solvent. The conductive polymer solution may further contain a high boiling point solvent.

The method may further include an electrolytic solution impregnation process of impregnating the wound body with the electrolytic solution. The solid electrolytic capacitor may further include electrolytic solution impregnated in the wound body.

In the solid electrolyte formation process, the wound body may be immersed in the conductive polymer solution to a connection portion between the round bar portion and the lead wire or 2 mm or higher from one end surface of the wound body. The conductive polymer may be attached to a connection portion between the round bar portion and the lead wire or 2 mm or higher from one end surface of the wound body.

### Effect of Invention

According to the present disclosure, the capacity appearance rate of the solid electrolytic capacitor is improved.

### BRIEF DESCRIPTION OF DRAWINGS

FIG. 1 is a schematic diagram of the wound body included in the solid electrolytic capacitor according to the present embodiment.

FIG. 2 is a schematic diagram of the lead terminal according to solid electrolytic capacitor according to the present embodiment.

FIG. 3 is a schematic diagram illustrating the liquid surface position of the conductive polymer solution or the attachment position of the conductive polymer.

FIG. 4 is a graph illustrating the relationship between the immersion liquid surface height of the conductive polymer solution and the attached amount of the conductive polymer.

FIG. 5 is a graph illustrating the relationship between the immersion liquid surface height of the conductive polymer solution and tan δ of the solid electrolytic capacitor.

FIG. 6 is a graph illustrating the relationship between the immersion liquid surface height of the conductive polymer solution and tan capacity appearance rate of the solid electrolytic capacitor.

### EMBODIMENTS

Hereinafter, a solid electrolytic capacitor and a manufacturing method thereof according to the embodiment of the present disclosure will be described. Note that the present disclosure is not limited to the following embodiments. Also, each figure may emphasize and show the thickness, dimension, positional relationship, ratio, numbers, shape, and the like for the case of understanding, and the present disclosure is not limited to such emphasis.

### Overall Configuration and Manufacturing Method

A solid electrolytic capacitor is a passive element that gains the capacitance by the dielectric polarization of dielectric film, stores and discharges electric charge, and for example, has the height of about 40 mm or less. This solid electrolytic capacitor includes anode foil in which dielectric film is formed on a surface thereof, an cathode foil. The anode foil and the cathode foil are arranged to face each other. A separator is intervened between the anode foil and the cathode foil to prevent short-circuit of the anode foil and the cathode foil.

Conductive polymer is attached on the dielectric film of the anode foil. The conductive polymer is an electrolyte of the solid electrolytic capacitor, and is arranged to be linked between the dielectric film and the cathode foil to form a conductive path and act as a true cathode. Electrolytic solution can be used together for the solid electrolytic capacitor. The electrolytic solution fills voids between the dielectric film and the conductive polymer.

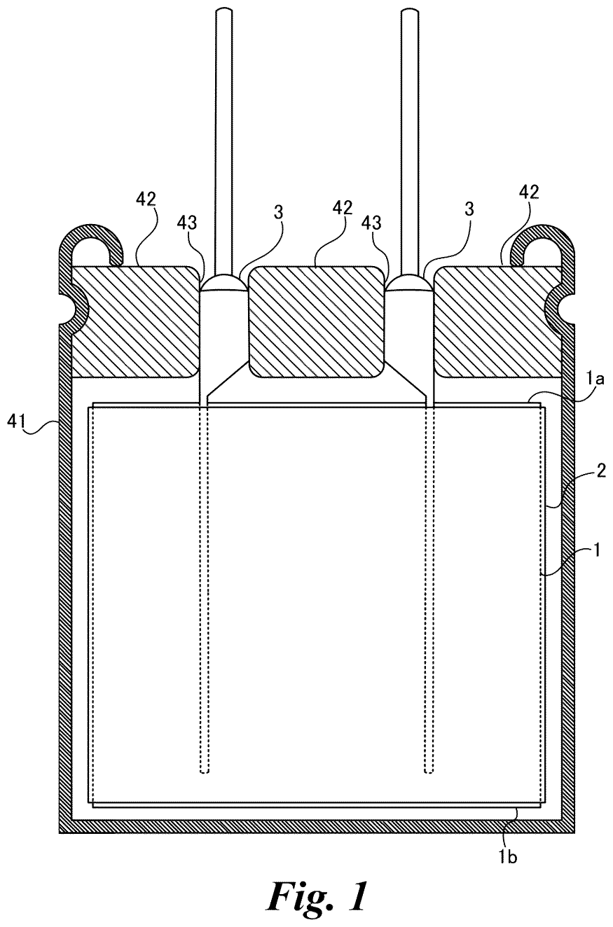

FIG. 1 is a schematic diagram of the wound body included in the solid electrolytic capacitor. The solid electrolytic capacitor is a wound-type. That is, the solid electrolytic capacitor electrolytic includes a wound body 1. The wound body 1 is formed by spirally winding a laminate of the anode foil, the cathode foil, and the separator multiple times, and has a cylindrical shape. The anode foil and the cathode foil are a strip-shaped foil body. The strip-width direction and the central axis of the wound body 1 are matched, and the foil are wound so that the strip-longitudinal direction thereof is rounded. This process of winding the anode foil, the cathode foil, and the separator to form the wound body 1 is called the winding process.

Before the winding process, lead terminals 3 are connected to the anode foil and the cathode foil, respectively. The lead terminal 3 is electrically or mechanically connected to the anode foil and the cathode foil by cold-welding, ultrasonic welding, or laser welding, etc. The lead terminal 3 protrudes from one of derived end surfaces 1a of the wound body 1 and is a conductor to electrically connect the solid electrolytic capacitor and a mounting board.

After the winding process, a strip of an adhesive tape 2 is wrapped on the outer circumference of the wound body 1. The adhesive tape 2 is wrapped on at least the outer end of the strip to prevent the wound body 1 from unraveling. The process to wrap the circumferential surface of the wound body 1 by the adhesive tape 2 is called the wrapping process. The adhesive tape 2 has a hydrophobic substrate such as polypropylene for water resistance against moisture during the manufacturing process of the solid electrolytic capacitor. An adhesive layer is laminated on this hydrophobic substrate, so that the adhesive tape 2 is hydrophobic.

The width of the adhesive tape 2 in the strip-width direction is the same length or substantially the same length as the axial length of the wound body 1. The adhesive tape 2 is wrapped on the wound body 1 so as to at least cover the outer end of the strip of the wound body 1. Furthermore, the adhesive tape 2 is wrapped on the wound body 1 so that a side edge of the adhesive tape 2 in the strip-length direction is on the same plane or substantially the same plane as the conductive end surface 1a and the opposite end surface 1b of the wound body 1.

The winding process is followed by a solid electrolyte formation process. However, the solid electrolyte formation process may not be performed immediately after the winding process, and for example, re-chemical conversion process to repair damages of the dielectric film due to the winding process, and other processes may be performed. In the solid electrolyte formation process, the conductive polymer is attached in the wound body 1. The conductive polymer covers at least a part of dielectric film.

The conductive polymer is formed in the wound body 1 using conductive polymer solution. The conductive polymer solution is dispersion or solution in which the conductive polymer is dispersed or dissolved. The main solvent of the conductive polymer solution is water, and powder or particles of the conductive polymer is dispersed or dissolved in water. In the solid electrolyte formation process, the wound body 1 is immersed in conductive polymer solution to impregnate the conductive polymer solution. The wound body 1 may be immersed in the conductive polymer solution once or multiple times. The wound body 1 may be immersed in the conductive polymer solution under the depressurized environment.

After the conductive polymer solution is impregnated in the wound body 1, the solvent of the conductive polymer solution is removed by drying. For example, the temperature environment in the drying process is 40 to 200° C., and the drying time is 3 to 180 minutes. The drying process may be repeated multiple times. The drying process may be performed under the depressurized environment, for example, under the pressure of 5 to 100 kPa.

To impregnate the electrolytic solution, the solid electrolyte formation process is followed by an impregnation process to impregnate the electrolytic solution is performed. The wound body 1 to which the conductive polymer is attached is impregnated with the electrolytic solution under the atmospheric environment or depressurized environment once or multiple times. Then, after the solid electrolyte formation process or the electrolytic solution impregnation process, the wound body 1 filled with the conductive polymer or both the conductive polymer and electrolytic solution, that is, a capacitor element is inserted in an cylindrical outer casing 41 with a bottom and is sealed by a sealing member 42.

The sealing member 42 is an elastic body to seal the capacitor element in the outer casing and has an insertion hole 43 through which the lead terminal 3 penetrates. The lead terminal 3 is press-fit into the insertion hole 43 and is drawn out from the sealing member 42. The aging process is performed to the solid electrolytic capacitor to complete the manufacture. In the aging process, DC current is applied on the solid electrolytic capacitor to repair the defects such as in the dielectric oxide film.

Note the capacitor element may be covered by laminate film instead of the outer casing. Furthermore, the capacitor element may be molded by resin such as heat-resistant resin or insulative resin. The capacitor element may be sealed by forming thin film of said resin using method such as dip-coating and printing, etc.

### Detailed Configuration and Manufacturing Method Electrode Foil

The anode foil is a long foil body formed of valve action metal. The valve action metal is aluminum, tantalum, niobium, niobium oxide, titanium, hafnium, zirconium, zinc, tungsten, bismuth, and antimony, etc. The cathode foil is a long foil body formed of valve action metal as same as the anode foil or other metal such as silver. The cathode foil may be a layered foil body in which a carbon layer is laminated on a silver layer. The purity of the anode foil is desirably 99.9% or more, and the purity of the cathode foil is desirably 99% or more, however, impurities such as silicon, iron, copper, magnesium, zinc, and the like may be included.

The long foil body may be formed by elongating, for example, valve action metal, or may be formed by sintering powder of valve action metal. An enlarged surface layer is formed on one or both surface of the anode foil. The enlarged surface layer is an etching layer in which etching is performed on the foil body, a sintered layer in which powder of valve action metal is sintered, or a vapor-deposited layer in which particles of valve action metal are vapor-deposited on the foil body. That is, the enlarged surface layer has a porous structure and is formed by tunnel-shaped pits, spongy pits, or air gaps between dense powder bodies or particles.

The tunnel-shaped etching pits are holes dug in the thickness direction of the foil. Typically, the tunnel-shaped etching pits are formed by applying DC current on the foil body in aqueous acidic solution in which halogen ions are present, such as hydrochloric acid. Furthermore, the tunnel-shaped etching pits are enlarged by applying DC current on the foil body in aqueous acidic solution such as nitric acid. The spongy pits make the enlarged surface layer a spongy layer with a series of fine spatial air gaps. The spongy etching pits are formed by applying AC current on the foil body in aqueous acidic solution in which halogen ions are present, such as hydrochloric acid.

The sintered layer is formed by obtaining powder of valve action metal same as or different from that of the foil body using grinding, atomizing, melt-spinning, rotating disk, rotating electrode, or other method, making a paste from the powder using a binder or a solvent, applying the paste on the foil body, drying the foil body, and heating and sintering the foil body in vacuum or in reduction atmosphere. The atomizing may be either of water atomizing, gas atomizing, or water-gas atomizing. For example, the vapor-deposited layer is produced by resistance heating vapor-deposition or electron beam heating vapor-deposition. The vapor-deposited layer is formed by heating and evaporating valve action metal same as or different from that of the foil body using resistive heat and electron beam energy, and depositing vapor of the particles of valve action metal on the surface of the foil body.

The dielectric film is formed on an uneven surface of the enlarged surface layer. Typically, the dielectric film is oxide film formed on the uneven surface layer of the enlarged surface layer, and when the anode foil is made of aluminum, the dielectric film is an aluminum oxide layer obtained by oxidizing the uneven surface layer of the enlarged surface layer. In the chemical conversion treatment to form the dielectric film, voltage is applied on the anode foil in chemical conversion solution to achieve the desired withstand voltage. The chemical conversion solution is solution without halogen ions, and for example is phosphoric acid-based chemical conversion solution such as ammonium dihydrogen phosphate, boric acid-based chemical conversion solution such as ammonium borate, and adipic acid-based chemical conversion solution such as ammonium adipate, etc.

The enlarged surface layer is formed on the cathode foil like the anode foil, if necessary. The cathode foil may be plane foil without the enlarged surface layer. The dielectric film may be formed on the cathode foil, like the anode foil. The cathode foil may have natural oxide film, or thin oxide film (about 1 to 10 V) formed by the chemical conversion treatment. The natural oxide film is formed when oxygen in the air reacts with the cathode foil.

Note that a conductive layer may be laminated on the surface of the cathode foil. For example, the conductive layer is a layer containing metal nitride, metal carbide, and metal carbonitride of titanium, zirconium, tantalum, or niobium, and carbon. The metal nitride, metal carbide, metal carbonitride, and carbon are formed by vapor-deposition, or application of a slurry, etc.

### Lead Terminal

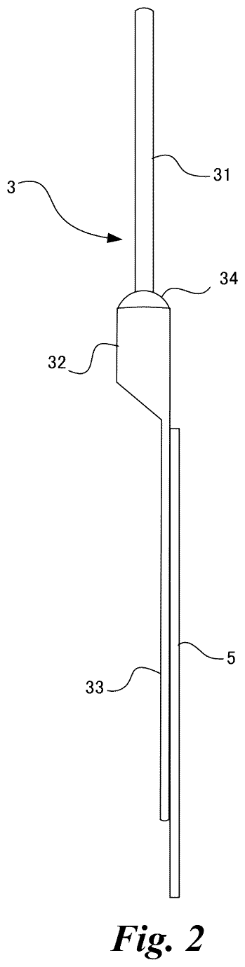

FIG. 2 is a schematic-sectional diagram of the lead terminal 3. The lead terminal 3 penetrates and is drawn out from the sealing member 4, and is formed by lead wire 31, a round bar portion 32, and a flat portion 33 arranged in series. The sealing member 42 is an elastic body to seal the capacitor element inside the outer casing and has the insertion hole 43 through which the lead terminal 3 penetrates. The lead wire 31 is an electrical wire extending outside the scaling member 42 and electrically connecting the solid electrolytic capacitor and the mounting board. Generally, the lead wire 31 is Cu-plated wire, which is called CP wire, and has solder plating such as lead or tin on the surface thereof.

Typically, the round bar portion 32 is made of aluminum and is a round bar with a substantially cylinder shape. However, the cross-sectional shape of the round bar portion 32 is not limited to a perfect circle, and may be an oval shape, a polygonal shape such as a triangle and a square, or other shapes. The lead wire 31 and the round bar portion 32 is connected such as by arc-welding and a connection portion 34 by welding intervenes between the lead wire 31 and the round bar portion 32. Alternatively, the lead wire 31 may be formed from a part of the round bar portion 32. The round bar portion 32 is one size larger than the insertion hole 43 of the scaling member 42. The round bar portion 32 is press-fit in the insertion hole 43 and closely contacts the inner wall of the insertion hole 43 due to an increase in the internal pressure of the scaling member after caulking.

The flat portion 33 is formed by crushing the opposite side of the round bar portion 32 from the lead wire 31 into a flat plate such as by pressing. Note that the boundary between the round bar portion 32 and the flat portion 33 is an inclined portion in which the thickness is linearly decreases to the thickness of the flat portion 33. This inclined portion is included in the round bar portion 32.

The flat portion 33 is electrically or mechanically connected to each of the electrode foil 5 that are called the anode foil and the cathode foil by stitching, cold-welding, ultrasonic welding, or laser welding, etc. The flat portion 33 contacts one surface and one of the long sides of the electrode foil 5, the round bar portion 32 and the lead wire 31 protrude from the electrode foil 5 so that the round bar portion 32 and the lead wire 31 is orthogonal to the long side of the electrode foil 5, and the flat portion 33 is connected to the electrode foil 5. The winding process is performed after these lead terminals 3 are connected to the electrode foil 5, respectively.

### Separator

The separator prevents a short-circuit between the anode foil and the cathode foil and holds the conductive polymer and the electrolytic solution. The separator includes cellulose such as kraft, Manila hemp, esparto, hemp, rayon, and mixed papers thereof, polyester resin such as polyethylene terephthalate, polybutylene terephthalate, polyethylene naphthalate, and derivatives thereof, polytetrafluoroethylene resin, polyvinylidene fluoride resin, vinylon resin, polyamide resin such as aliphatic polyamide, semi-aromatic polyamide, and total aromatic polyamide, polyimide resin, polyethylene resin, polypropylene resin, trimethylpentene resin, polyphenylene sulfide resin, acrylic resin, polyvinyl alcohol resin, and the like, and the resin may and may be used in single or in mixture.

The separator may be fibrillated by creating fine fiber branched out from the surface of the original fiber, like fibrillated cellulose, for example. For example, the fibrillation can be performed by beating. The fibrillated fiber intertwines with each other using fibrillated fine fiber, improving the rigidity of the separator is improved. Accordingly, the separator can be thinner.

However, the separator with the air permeability of 5.5 [s/100 mL] or less is used for the wound body 1. If the air permeability of the separator is 5.5 [s/100 mL] or less, even when the wound body is wrapped by the hydrophobic adhesive tape 2, the conductive polymer solution can be immersed at half the height or higher of the round bar portion 32 and the conductive polymer can be attached to half the height or higher of the round bar portion in the solid electrolyte formation process, so that the attached amount of the conductive polymer in the wound body 1 becomes excellent. Accordingly, the capacity appearance rate of the solid electrolytic capacitor becomes excellent.

Here, the air permeability is also called a Gurley value and is a time required for 100 mL of air to pass through the separator. The air permeability is measured by the Gurley method in accordance with JIS P8117:2009. A gasket with the inner diameter of 28.6 mm is used for the measurement. However, for the separator with the air permeability of 1 [s/100 mL] or less, a gasket with the inner diameter of 6 mm is used for the measurement, and the result value is converted into a value measured with the inner diameter of 28.6 mm. In detail, the conversion formula in which the value obtained with the inner diameter of 6 mm is multiplied by 62/28.62.

The capacity appearance rate is a ratio of the capacitance of the solid electrolytic capacitor relative to the synthesized capacity of the anode foil and cathode foil and is a percentage of a result obtained by dividing the capacitance of the solid electrolytic capacitor by the synthesized capacity of the anode foil and the cathode foil. The synthesized capacity of the anode foil and the cathode foil is the synthesized capacity of the solid electrolytic capacitor regarded as a capacitor in which the anode-side and the cathode-side are connected in series. When the cathode foil has the conductive layer or when it can be said that the capacitance of the cathode body asymptotes to infinity, the synthesized capacitance of the anode foil and the cathode foil is the capacitance of the anode foil.

### Conductive Polymer

The conductive polymer is a self-doped conjugated polymer doped by intramolecular dopants or a conjugated polymer doped by external dopant molecules. The conjugated polymer is obtained by chemical oxidative polymerization or electrolytic oxidative polymerization of monomers with a x-conjugated double bond or derivatives thereof. The dopant or the external dopant molecule is an acceptor that easily accepts electrons in the conjugated polymer or a donor that easily donates electrons to the conjugated polymer, so that the conductive polymer exhibits high conductivity.

Known polymers may be used for the conjugated polymer without limitation. For example, the conjugated polymer may be polypyrrole, polythiophene, polyfuran, polyaniline, polyacetylene, polyphenylene, polyphenylenevinylene, polyacene, and polythiophenevinylene, etc. These conjugated polymers may be used in single or in combination of two or more, and may further be a copolymer of two or more types of monomers.

Among the above-described conjugated polymers, conjugated polymers formed by polymerizing thiophene or derivatives thereof is preferable, and conjugated polymers in which 3,4-ethylenedioxythiophene (that is, 2,3-dihydrothieno[3,4-b][1,4]dioxin), 3-alkylthiophene, 3-alkylthiophene, 3-alkyl-4-alkylthiophene, 3,4-alkylthiophene, 3,4-alkoxythiophene, or derivatives thereof are polymerized are preferable. The thiophene derivatives may preferably be compounds selected from thiophene with substituents at 3-position and 4-position, and the 3-position and 4-position substituents of the thiophene ring may form a ring together with the 3-position and 4-position carbon. It is preferable that the carbon number of an alkyl group and an alkoxy group is 1 to 16.

In particular, a polymer of 3,4-ethylenedioxythiophene which is called EDOT, that is, poly(3,4-ethylenedioxythiophene) which is called PEDOT is preferable. Furthermore, substituents may be added to 3,4-ethylenedioxythiophene. For example, alkylated ethylenedioxythiophene to which an alkyl group with carbon number of 1 to 5 is added as a substituent may be used. For example, alkylated ethylenedioxythiophene may be methylated ethylenedioxythiophene (that is, 2-methyl-2,3-dihydro-thieno[3,4-b][1,4]dioxin), ethylated ethylenedioxythiophene (that is, 2-ethyl-2,3-dihydro-thieno[3,4-b][1,4]dioxin), butylated ethylenedioxythiophene (that is, 2-butyl-2,3-dihydro-thieno[3,4-b][1,4]dioxin), and 2-alkyl-3,4-ethylenedioxythiophene may be used.

As the dopant, known dopants may be used without limitation. The dopant may be used in single or in combination of two or more. Also, the dopant may be polymers or monomers. For example, the dopant may be inorganic acid such as polyanions, boric acid, nitric acid, and phosphoric acid, and organic acid such as acetic acid, oxalic acid, citric acid, tartaric acid, squaric acid, logisonic acid, croconic acid, salicylic acid, p-toluenesulfonic acid, 1,2-dihydroxy-3,5-benzenedisulfonic acid, methanesulfonic acid, trifluoromethanesulfonic acid, borodisalicylic acid, bisoxalate borate acid, sulfonylimide acid, dodecylbenzenesulfonic acid, propylnaphthalenesulfonic acid, and butylnaphthalenesulfonic acid.

For example, the polyanion may be polymers consisting of only component units with anion groups or polymers consisting of component units with anion groups and component units without anion groups, and may be substituted or unsubstituted polyalkylene, substituted or unsubstituted polyalkenylene, substituted or unsubstituted polyimide, substituted or unsubstituted polyamide, and substituted or unsubstituted polyester. In particular, the polyanion may be polyvinyl sulfonic acid, polystyrene sulfonic acid, polyaryl sulfonic acid, polyacrylic sulfonic acid, polymethacrylic sulfonic acid, poly(2-acrylamide-2-methylpropane sulfonic acid), polyisoprene sulfonic acid, polyacrylic acid, polymethacrylic acid, and polymaleic acid, etc.

For such a conductive polymer, for example, poly(3,4-ethylenedioxythiophene) doped with polystyrene sulfonic acid may be used, and hereinafter this conductive polymer is referred to as PEDOT/PSS.

In the solid electrolyte formation process, the wound body 1 is immersed in conductive polymer solution to attach the conductive polymer in the wound body 1. The conductive polymer solution is dispersion or solution in which the conductive polymer is dispersed or dissolved. The conductive polymer solution is prepared by purifying the solution after the chemical polymerization or electrolytic polymerization using ultrafiltration, cation exchange, and anion exchange, removing residual monomers and impurities, and dispersing or dissolving the conductive polymer in the solvent, or is prepared by adding, and dispersing or dissolving particles or powder of the conductive polymer in the solvent.

The main solvent of the conductive polymer solution is water. The solvent of the conductive polymer dispersion may be mixture solution of water and an organic solvent if the particles or powder of the conductive polymer can be dispersed or dissolved. Suitable organic solvent may be polar solvents, alcohol, esters, hydrocarbons, carbonate compounds, ether compounds, chain ethers, heterocyclic compounds, and nitrile compounds, etc.

The polar solvent may be N-methyl-2-pyrrolidone, N,N-dimethylformamide, N,N-dimethylacetoamide, and dimethylsulfoxide. The alcohol may be methanol, ethanol, propanol, and butanol, etc. The ester may be ethyl acetate, propyl acetate, and butyl acetate, etc. The hydrocarbon may be hexane, heptane, benzene, toluene, and xylene, etc. The carbonate compound may be ethylene carbonate and propylene carbonate, etc. The ether compound may be dioxane, diethylether, etc. The chain ether may be ethylene glycol alkyl ether, propylene glycol alkyl ether, polyethylene glycol dialkyl ether, and polypropylene glycol alkyl ether, etc. The heterocyclic compound may be 3-methyl-2-oxazolidinone, etc. The nitrile compound may be acetonitrile, glutaronitrile, methoxyacetonitrile, propionitrile, and benzonitrile, etc.

The pH of the conductive polymer solution is adjusted, and polyhydric alcohol and various additives may be added as necessary. For example, the pH adjuster may be ammonia water, sodium hydroxide, primary amines, secondary amines, and tertiary amines. The polyhydric alcohol may be sorbitol, ethylene glycol, diethylene glycol, triethylene glycol, polyoxyethylene glycol, polyoxypropylene glycol, glycerin, polyglycerin, polyoxyethylene glycerin, xylitol, erythritol, mannitol, dipentacrythritol, pentaerythritol, or combination of two or more. The polyhydric alcohol is a high boiling point solvent which has a high boiling point and remains in the wound body 1 even after the wound body 1 is impregnated with the conductive polymer solution and is dried. Therefore, the polyhydric alcohol gives the ESR reduction and withstand voltage improvement. For example, the additive may be organic binders, surfactant, dispersant, defoamer, coupling agent, antioxidant, and UV absorber, etc.

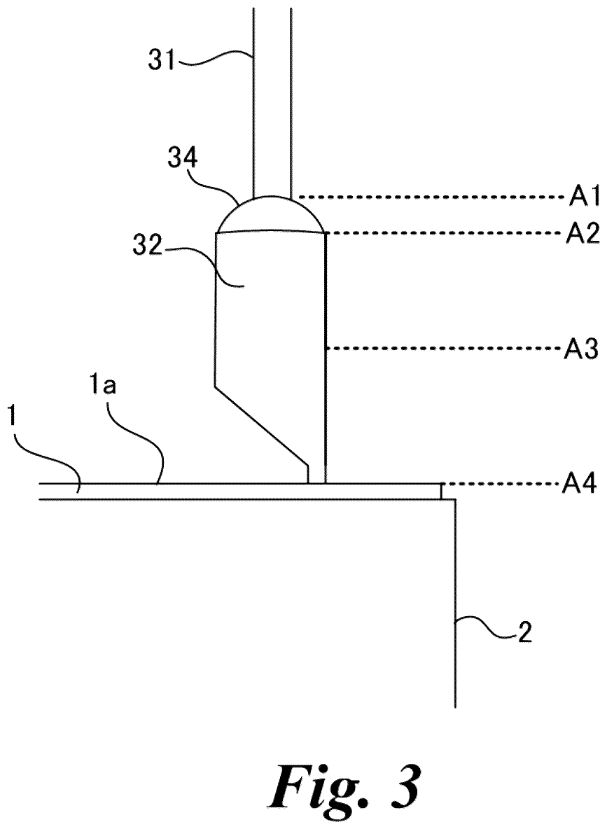

In the solid electrolyte formation process, the wound body 1 is immersed in the conductive polymer solution with the opposite end surface 1b of the wound body 1 facing downward. FIG. 3 is a schematic diagram illustrating the liquid surface position of the conductive polymer solution or the attachment position of the conductive polymer. As illustrated in FIG. 3, the boundary position between the lead wire 31 of the lead terminal 3 and an upper end of the connection portion 34 is defined as an upper end A1 of the connection portion. The boundary position between a lower end of the connection portion 34 of the lead terminal 3 and the round bar portion 32 is defined as a lower end A2 of the connection portion. The position that is 1 mm or higher from the derived end surface 1a of the wound body 1 is define as A3. For example, A3 is a position at half a height in the length direction of the round bar portion 32. Furthermore, the derived end surface 1a of the wound body 1 is defined as an end surface position A4.

At this time, the wound body 1 is immersed in the conductive polymer solution so that the liquid surface of the conductive polymer solution is between the height position A3 of 1 mm or higher from the derived end surface 1a of the wound body and the upper end A1 of the connection portion, such as at the height position A3 of half the round bar. In other word, the conductive polymer is attached in the range between at least the position A3 of the lead terminal 3 and the upper end A1 of the connection portion, in addition to in the conductive polymer. A meniscus is formed because the contact angle between the hydrophobic adhesive tape and the conductive polymer solution is large. Therefore, the wound body 1 must be immersed in the conductive polymer solution beyond the upper edge of the adhesive tape 2.

Accordingly, the conductive polymer solution is absorbed up from the opposite end surface 1b and drips down from the derived end surface 1a. Therefore, in the solid electrolyte formation process, by immersing the wound body 1 in the conductive polymer solution at the position A3 at least at half the height or higher of the round bar portion 32 or at the height position A3 of 1 mm or higher from the derived end surface 1a of the wound body, the conductive polymer solution is excellently impregnated even to the wound body 1 wrapped by the adhesive tape 2. The conductive polymer solution that has entered from the derived end surface 1a and the opposite end surface 1b seeps into the wound body 1 via the separator. The solid electrolytic capacitor has excellent capacity appearance rate and reduced dissipation factor (tan δ).

The impregnation time of the conductive polymer solution can be set according to the size of the wound body 1 as appropriate. There is no adverse effect to the properties even if the impregnation time is long. In the impregnation of the wound body 1, depressurization process or pressurization process may be performed to facilitate the impregnation, as necessary. The solid electrolyte formation process may be repeated multiple times. The solvent of the conductive polymer solution is removed by evaporation by drying, as necessary. To remove the solvent, heat drying and depressurization drying may be performed, as necessary.

In the winding process, it is preferable to intervene the separator with air permeability of 5.5 [s/100 mL] or less between a pair of the electrodes 5. By this, the conductive polymer solution that has entered from the derived end surface 1a and the opposite end surface 1b easily seeps into the wound body 1 via the separator.

The viscosity of the conductive polymer solution is preferably 10 mPa·s to 60 mPa·s. The conductive polymer solution with viscosity of 60 mPa·s or less easily seeps into the wound body 1. Therefore, the conductive polymer solution impregnated in the wound body 1 is increased, and the conductive polymer attached in the wound body 1 is increased. Accordingly, the capacity appearance rate of the solid electrolytic capacitor becomes further excellent. The viscosity of the conductive polymer solution is particular preferably 45 mPa·s or less. When the viscosity of the conductive polymer solution is 45 mPa·s or less, the capacity appearance rate of the solid electrolytic capacitor becomes further more excellent. For example, the viscosity is adjusted by the processing time using dispersion method such as ultrasonic homogenizers or jet mixing, the type and amount of dispersion media, the type and amount of additives, the polymerization level of polymers, and the concentration of polymers.

Note that the repair chemical conversion treatment may be performed between the winding process and the solid electrolyte formation process to repair defects such as cracks, damages, and voids at each site of the dielectric film due to insufficient formation of the dielectric film and bending stress by winding. The chemical conversion solution used for the repair chemical conversion is aqueous solution in which phosphoric acid-based chemical conversion solution such as ammonium dihydrogen phosphate and diammonium hydrogen phosphate, boric acid-based chemical conversion solution such as ammonium borate, and adipic acid-based chemical conversion solution such as ammonium adipate are dissolved in water. For example, voltage is preferably 0.1 to 1.2 times the chemical conversion voltage. Then, to remove the chemical conversion solution from the wound body 1, the wound body 1 immersed in the chemical conversion solution is washed by chemical conversion washing solution such as pure water.

### Electrolytic Solution

When the electrolytic solution is used together in the solid electrolytic capacitor, the solid electrolyte formation process is followed by the electrolytic solution impregnation process. The electrolytic solution is mixture solution in which a solute is dissolved in a solvent, and additives are added as necessary. The electrolytic solution may only contain the solvent and does not dissolve the solute, or may contain the solvent and the additive. The solvent of the electrolytic solution may be a protic organic polar solvent or an aprotic organic polar solvent, and may be used in single or in combination of two or more. Furthermore, the solute of the electrolytic solution contains anion components and cation components. Typically, the solute is organic acid salt, inorganic acid salt, or salt of composite compound of organic acid and inorganic acid, and may be used in single or in combination of two or more. Acid that is the anion and base that is the cation may be separately added to the solvent.

The protic organic polar solvent that is the solvent may be monohydric alcohol, polyhydric alcohol, and oxyalcohol compound, etc. The monohydric alcohol may be ethanol, propanol, butanol, pentanol, hexanol, cyclobutanol, cyclopentanol, cyclohexanol, and benzyl alcohol, etc. The polyhydric alcohol and the oxyalcohol compound may be ethylene glycol, propylene glycol, glycerin, polyglycerin, methyl cellosolve, ethyl cellosolve, methoxypropylene glycol, dimethoxypropanol, and alkylene oxide adducts of polyhydric alcohol such as polyethylene glycol and polyoxyethylene glycerin, etc. Among them, the solvent is desirably polyhydric alcohol and particularly preferably ethylene glycol and glycerin. Ethylene glycol and glycerin cause a change in the high-order structure of the conductive polymer, and the conductive polymer has the excellent initial ESR property and excellent high-temperature property. It is further preferable that ethylene glycol is present in the solvent in an amount of 30 wt % or more.

The aprotic organic polar solvent that is the solvent may be sulfones, amides, lactones, cyclic amides, nitriles, and sulfoxides, etc. The sulfone may be dimethyl sulfone, ethylmethyl sulfone, diethyl sulfone, sulfolane, 3-methyl sulfolane, and 2,4-dimethyl sulfolane, etc. The amide may be N-methylformamide, N,N-dimethylformamide, N-ethylformamide, N,N-diethylformamide, N-methylacetamide, N,N-dimethylacetamide, N-ethylacetamide, N,N-diethylacetamide, and hexamethylphosphoricamide, etc. The lactone and the cyclic amide may be γ-butyrolactone, γ-valerolactone, δ-valerolactone, N-methyl-2-pyrrolidone, ethylene carbonate, propylene carbonate, butylene carbonate, and isobutylene carbonate, etc. The nitrile may be acetonitrile, 3-methoxypropionitrile, and glutaronitrile, etc. The sulfoxide may be dimethyl sulfoxide, etc.

The organic acid that becomes the anion component as the solute may be carboxylic acid such as oxalic acid, succinic acid, glutaric acid, pimelic acid, suberic acid, sebacic acid, phthalic acid, isophthalic acid, terephthalic acid, maleic acid, adipic acid, benzoic acid, toluyl acid, enanthic acids, malonic acids, 1,6-decandicarboxylic acid, 1,7-octanedicarboxylic acid, azclaic acid, undecanedioic acid, dodecanedioic acid, tridecanedioic acid, t-butyladipic acid, 11-vinyl-8-octadecenedioic acid, resolcinic acid, fluorochloric acid, gallic acid, gentisic acid, protocatechuic acid, pyrocatechuic acid, trimellitic acid, and pyromellitic acid, phenols, and sulfonic acid, etc.

The inorganic acid may be boric acid, phosphoric acid, phosphorus acid, hypophosphorous acid, carbonic acid, and silicic acid, etc. The composite compound of organic acid and inorganic acid may be borodisalicylic acid, borodioxalic acid, borodiglycolic acid, borodimalonic acid, borodisuccinic acid, borodiadipic acid, borodiazelaic acid, borodibenzoic acid, borodimaleic acid, borodilactic acid, borodimalic acid, boroditartric acid, borodicitric acid, borodiphthalic acid, borodi(2-hydroxy) isobutyric acid, borodiresorcinic acid, borodimethylsalicylic acid, borodinaftocic acid, borodimandelic acid, and borodi(3-hydroxy) propionic acid, etc.

Furthermore, at least one salt of the organic acid, the inorganic acid, and the composite compound of organic acid and inorganic acid may be ammonium salt, quaternary ammonium salt, quaternary amidinium salt, amine salt, sodium salt, and potassium salt, etc. Quaternary ammonium ions of the quaternary ammonium salt may be tetramethylammonium, triethylmethylammonium, and tetraethylammonium, etc. The quaternary amidinium may be ethyldimethylimidazolinium and tetramethylimidazolinium, etc. The amine salt may be primary amines, secondary amines, and tertiary amines. The primary amine may be methylamine, ethylamine, propylamine, and the like, the secondary amines may be dimethylamine, diethylamine, ethylmethylamine and dibutylamine, and the like, and the tertiary amines may be trimethylamine, triethylamine, tributylamine, ethyldimethylamine, ethyldiisopropylamine, and the like.

Furthermore, other additives may be added to the electrolytic solution. The additives may be complex compounds of boric acid and polysaccharides (mannit, sorbit, etc.), complex compounds of boric acid and polyhydric alcohol, borate esters, nitro compounds (o-nitrobenzoic acid, m-nitrobenzoic acid, p-nitrobenzoic acid, o-nitrophenol, m-nitrophenol, p-nitrophenol, p-nitrobenzylalcohol etc.), and phosphate esters, etc. These may be used in single or in combination of two or more. The addition amount of the additive is not particularly limited, but is preferably added in an amount that does not give adverse effect to the properties of the solid electrolytic capacitor, such as 60 wt % or less in the electrolytic solution.

Hereinafter, the solid electrolytic capacitor and the manufacturing method thereof of the present disclosure will be described in more detail based on examples. Note that the present disclosure is not limited to the below examples.

### Example 1

As in below, a solid electrolytic capacitor of the example 1 was produced. Firstly, anode foil and cathode foil was long elongated strip-shaped aluminum foil. Surfaces of the anode foil and cathode foil were enlarged by AC etching. After the surface enlargement, chemical conversion treatment was performed on the anode foil to form dielectric film.

Lead terminals 3 were attached to each of the anode foil and the cathode foil by stitch connection portion. A fibrillated cellulose separator was intervened between the anode foil and the cathode foil connected to the lead terminal 3, and they are wound so that the strip-longitudinal direction was rounded to form a wound body 1. In the solid electrolytic capacitor of the example 1, a fibrillated cellulose separator with air permeability of 5.48 [s/100 mL] was used.

Adhesive tape 2 having width with the same length as the axial direction of the wound body 1 was prepared, and this adhesive tape 2 was wrapped around the outer circumference of the wound body 1. Voltage of 57 V was applied on the wound body 1 in chemical conversion solution to perform repair chemical conversion treatment.

The wound body 1 was impregnated with conductive polymer solution. In the conductive polymer solution, poly(3,4-ethylenedioxythiophene) doped with polystyrene sulfonic acid (PSS) (PEDOT/PSS) was dispersed in water. PEDOT/PSS was added in a ratio of 1.2 wt % relative to the total conductive polymer solution. Furthermore, ethylene glycol was added to the conductive polymer solution in a ratio of 10 wt % relative to the total conductive polymer solution. In the solid electrolytic capacitor of the example 1, the viscosity of the conductive polymer solution was adjusted to 30 mPa·s by dispersion process using an ultrasonic homogenizer.

The wound body 1 was impregnated with the conductive polymer solution for 10 minutes in the depressurized environment of 80 kPa or less at room temperature. The wound body 1 was immersed in the conductive polymer solution, so that the height of the liquid surface of the conductive polymer solution was at an upper end A1 of a connection portion illustrated in FIG. 3 and the conductive polymer was attached to the wound body 1 to the height of the upper end A1 of the connection portion. After each impregnation process, the wound body 1 was placed still at room temperature for 10 minutes, and was further placed still in the temperature environment of 110° C. for 30 minutes to dry the wound body 1. A1 was a position of 2.7 mm from a derived end surface 1a of the wound body 1.

The wound body 1 after impregnation of the conductive polymer and drying was housed in an outer casing 41, and the outer casing 41 was sealed by a sealing member 42. The scaling member 42 and the outer casing 41 were adhered by caulking. The lead terminal 3 was press-fit into an insertion hole 43 of the sealing member 42, and the outer circumferential surface of a round bar portion 32 and the inner circumferential surface of the insertion hole 43 were adhered. An aging process to apply voltage of 40 V for 1 hour was performed on the produced solid electrolytic capacitor. As a result, the electrolytic capacitors of the example 1 with diameter of 10 mm and height of 10 mm, rated voltage of 35 WV, and rated capacitance of 270 μF was produced.

### Example 2

A solid electrolytic capacitor of the example 2 was produced. The examples 1 and 2 were common in the following points. That is, like the example 1, in the solid electrolytic capacitor of the example 2, a fibrillated cellulose separator with air permeability of 5.48 [s/100 mL] was used. The wound body 1 was impregnated with the conductive polymer solution with viscosity of 30 mPa·s. However, unlike the example 1, the wound body 1 of the example 2 was immersed in the conductive polymer solution, so that the height of the liquid surface of the conductive polymer solution was at an lower end A2 of the connection portion illustrated in FIG. 3 and the conductive polymer was attached to the wound body 1 to the height of the lower end A2 of the connection portion. For the other points, the example 2 was produced with the same configuration, the same manufacturing method, and the same manufacturing condition as the example 1. A2 was a position of 2 mm from the derived end surface 1a of the wound body 1.

### Example 3

A solid electrolytic capacitor of the example 3 was produced. The examples 1 and 3 were common in the following points. That is, like the example 1, in the solid electrolytic capacitor of the example 3, a fibrillated cellulose separator with air permeability of 5.48 [s/100 mL] was used. The wound body 1 was impregnated with the conductive polymer solution with viscosity of 30 mPa·s. However, unlike the example 1, the wound body 1 of the example 3 was immersed in the conductive polymer solution, so that the height of the liquid surface of the conductive polymer solution was at a position A3 illustrated in FIG. 3 and the conductive polymer was attached to the wound body 1 to the height of the position A3 of the connection portion. For the other points, the example 3 was produced with the same configuration, the same manufacturing method, and the same manufacturing condition as the example 1. A3 was a position of 1 mm from the derived end surface 1a of the wound body 1.

### Comparative Example 1

A solid electrolytic capacitor of the comparative example 1 was produced. The example 1 and the comparative example 1 were common in the following points. That is, like the example 1, in the solid electrolytic capacitor of the comparative example 1, a fibrillated cellulose separator with air permeability of 5.48 [s/100 mL] was used. The wound body 1 was impregnated with the conductive polymer solution with viscosity of 30 mPa·s. However, unlike the example 1, the wound body 1 of the comparative example 1 was immersed in the conductive polymer solution, so that the height of the liquid surface of the conductive polymer solution was at an end surface position A4 illustrated in FIG. 3 and the conductive polymer was attached to the wound body 1 to the height of the end surface position A4 of the connection portion. For the other points, the comparative example 1 was produced with the same configuration, the same manufacturing method, and the same manufacturing condition as the example 1.

### Attached Amount Test

The weight of the conductive polymer attached to the wound body 1 of the examples 1 to 3 and the comparative examples 1 was measured. The attached amount was calculated from the change in weight of the wound body 1 before and after the solid electrolyte formation process. The attached amount of the examples 1 to 3 was represented using the attached amount of the comparative example 1 as a reference (100%).

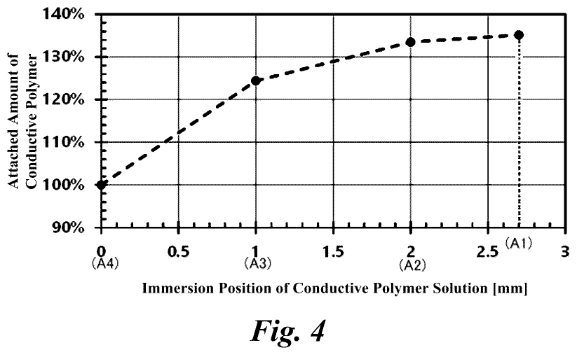

FIG. 4 illustrates the relationship between the weight of the conductive polymer attached to the wound body 1 of the examples 1 to 3 and the comparative examples 1 and the immersion liquid surface height of the conductive polymer solution.

As illustrated in FIG. 4, it was observed that the attached amount of the conductive polymer solution was greatly improved when the round bar half position A3, which is the height position of half the round bar portion 32 in the length direction, was the immersion liquid surface height of the conductive polymer solution and the attachment position of the conductive polymer in comparison with those in the case of the end surface position A4.

Furthermore, it was observed that the attached amount of the conductive polymer solution was further improved when the lower end A2 and upper end A1 of the connection portion, which is the height range of the connection portion 34 between the round bar portion 32 and the lead wire 31, was the immersion liquid surface height of the conductive polymer solution and the attachment position of the conductive polymer in comparison with those in the case of the end surface position A4.

### Capacitor Property

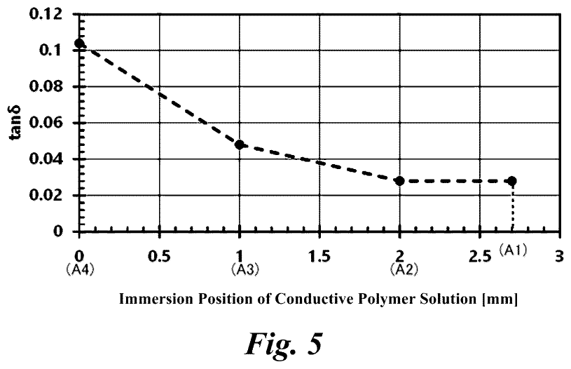

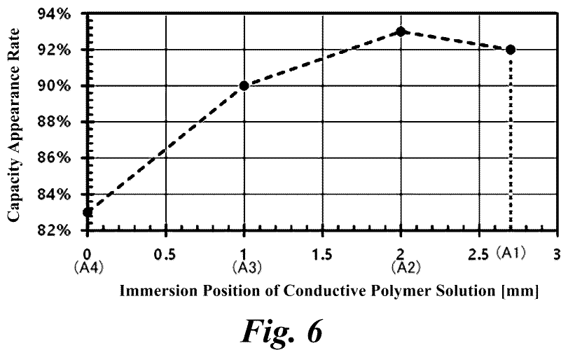

The dissipation factor (tan δ) and the capacity appearance rate (%) of the solid electrolytic capacitors of the examples 1 to 3 and the comparative example 1 were measured. The results are shown in FIGS. 5 and 6. The measurement result of the capacity appearance rate (%) is shown in the below table 1, and the measurement result of the dissipation factor (tan δ) is shown in the below Table 2.

TABLE 1

| | | | Viscosity | Immersion | |
|---|---|---|---|---|---|
| | | | of | Position | |
| | | Air | Conductive | of | Capacity |
| | Type | Perme- | Polymer | Conductor | Appear- |
| | of | ability | Solution | Polymer | ance |
| | Separator | [s/100 mL] | [mPa · S] | Solution | Rate |
| Example 1 | Fibrillated | 5.48 | 30 | A1 | 92% |
| Example 2 | Cellulose | | | A2 | 93% |
| Example 3 | | | | A3 | 90% |
| Compar- | | | | A4 | 83% |
| ative | | | | | |
| Example 1 | | | | | |

TABLE 2

| | | | Viscosity | Immersion | |
|---|---|---|---|---|---|
| | | | of | Position | |
| | | Air | Conductive | of | |
| | Type | Perme- | Polymer | Conductor | |
| | of | ability | Solution | Polymer | |
| | Separator | [s/100 mL] | [mPa · S] | Solution | tan δ |
| Example 1 | Fibrillated | 5.48 | 30 | A1 | 0.028 |
| Example 2 | Cellulose | | | A2 | 0.028 |
| Example 3 | | | | A3 | 0.048 |
| Comparative | | | | A4 | 0.104 |
| Example 1 | | | | | |

The dissipation factor (tan δ) was measured at room temperature using the LCR meter. The measurement frequency of tan δ was 120 kHz, and the AC amplitude was sine wave of 0.5 Vms. The leakage current was measured by applying voltage of 35 V for 120 seconds from the start of application under the temperature environment of 20° C.

The capacity of the anode foil and the cathode foil was measured by cutting out test pieces of predefined area from the anode foil and the cathode foil, immersing the test pieces in capacitance measurement solution in a glass measurement tank with a platinum plate as the facing electrode, and using the capacitance meter. For example, the capacitance measurement solution is aqueous solution of ammonium adipate of 30° C., the capacitance meter is a potentiostat and a frequency response analyzer, an electrochemical impedance analyzer or LCR meter, and the like, DC bias voltage was 1.5 V, and AC amplitude was 0.1 to 1 V.

As shown in the tables 1 and 2 and FIGS. 5 and 6, it was observed that tan δ and the capacity appearance rate were improved according to the attached amount of the conductive polymer in FIG. 4. That is, it was observed that the attached amount of the conductive polymer solution was greatly improved in the case of the height position A3 of half the round bar portion 32 in the length direction. Furthermore, it was observed that the attached amount of the conductive polymer solution was further improved in the case of the lower end A2 and upper end A1 of the connection portion, which is the height range of the connection portion 34 between the round bar portion 32 and the lead wire 31.

### Example 4

The solid electrolytic capacitor of the example 4 was produced. The examples 2 and 4 were common in the following points. That is, like the example 2, in the solid electrolytic capacitor of the example 4, the wound body 1 was impregnated with the conductive polymer solution with viscosity of 30 mPa·s. The wound body 1 was immersed in the conductive polymer solution, so that the height of the liquid surface of the conductive polymer solution was at the upper end A2 of a connection portion illustrated in FIG. 3 and the conductive polymer was attached to the wound body 1 to the height of the upper end A2 of the connection portion. However, unlike the example 2, in the example 4, a natural cellulose separator with air permeability of 0.03 [s/100 mL] was used. For the other points, the example 4 was produced with the same configuration, the same manufacturing method, and the same manufacturing condition as the example 2.

### Comparative Example 2

A solid electrolytic capacitor of the comparative example 2 was produced. Like the example 2, in the solid electrolytic capacitor of the comparative example 2, the wound body 1 was impregnated with the conductive polymer solution with viscosity of 30 mPa·s. Like the example 4, in the comparative example 2, a natural cellulose separator with air permeability of 0.03 [s/100 mL] was used. However, unlike the examples 2 and 4, the wound body 1 of the comparative example 2 was immersed in the conductive polymer solution, so that the height of the liquid surface of the conductive polymer solution was at the end surface position A4 illustrated in FIG. 3 and the conductive polymer was attached to 1 the height of the end surface position A4 of the connection portion. For the other points, the comparative example 2 was produced with the same configuration, the same manufacturing method, and the same manufacturing condition as the examples 2 and 4.

### Capacity Appearance Rate

The capacity appearance rate of the solid electrolytic capacitors of the example 4 and the comparative example 2 was measured. The results are shown in Table 3.

TABLE 3

| | | | Viscosity | Immersion | |
|---|---|---|---|---|---|
| | | | of | Position | |
| | | Air | Conductive | of | Capacity |
| | Type | Perme- | Polymer | Conductor | Appear- |
| | of | ability | Solution | Polymer | ance |
| | Separator | [s/100 mL] | [mPa · S] | Solution | Rate |
| Example 4 | Natural | 0.03 | 30 | A2 | 92% |
| Compar- | Cellulose | | | A4 | 82% |
| ative | | | | | |
| Example 2 | | | | | |

As illustrated in FIG. 3, in the example 4, since the air permeability was low but the immersion liquid surface height of the conductive polymer solution was the lower end A2 of the connection portion, the capacity appearance rate was excellent. In contrast, in comparative example 2, since the air permeability was low and the immersion liquid surface height of the conductive polymer solution was the end surface position A4, the capacity appearance rate became low. By this, it was observed that, even if the air permeability is low, when the immersion liquid surface height of the conductive polymer solution was at least at the position A3 or higher and the conductive polymer was attached to at least at the position A3 or higher, the capacity appearance rate became excellent.

### Example 5

The solid electrolytic capacitor of the example 5 was produced. The examples 2 and 5 were common in the following points. That is, like the example 2, in the solid electrolytic capacitor of the example 5, the wound body 1 was impregnated with the conductive polymer solution with viscosity of 30 mPa·s. The wound body 1 was immersed in the conductive polymer solution, so that the height of the liquid surface of the conductive polymer solution was at the upper end A2 of a connection portion illustrated in FIG. 3 and the conductive polymer was attached to the wound body 1 to the height of the upper end A2 of the connection portion. However, unlike the example 2, in the example 5, a fibrillated cellulose separator with air permeability of 1.77 [s/100 mL] was used. For the other points, the example 5 was produced with the same configuration, the same manufacturing method, and the same manufacturing condition as the example 2.

### Comparative Example 3

A solid electrolytic capacitor of the comparative example 3 was produced. The comparative example 3 and the examples 2 and 5 were common in the following points. That is, like the example 2, in the solid electrolytic capacitor of the comparative example 3, the wound body 1 was impregnated with the conductive polymer solution with viscosity of 30 mPa·s. The wound body 1 was immersed in the conductive polymer solution, so that the height of the liquid surface of the conductive polymer solution was at the upper end A2 of a connection portion illustrated in FIG. 3 and the conductive polymer was attached to the wound body 1 to the height of the upper end A2 of the connection portion. However, unlike the example 2, in comparative example 3, a fibrillated cellulose separator with air permeability of 5.76 [s/100 mL] was used. For the other points, the comparative example 3 was produced with the same configuration, the same manufacturing method, and the same manufacturing condition as the examples 2 and 5.

### Capacity Appearance Rate

The capacity appearance rate (%) of the solid electrolytic capacitors of the examples 2 and 5 and the comparative example 3 was measured. The results are shown in Table 4.

TABLE 4

| | | | Viscosity | Immersion | |
|---|---|---|---|---|---|
| | | | of | Position | |
| | | Air | Conductive | of | Capacity |
| | Type | Perme- | Polymer | Conductor | Appear- |
| | of | ability | Solution | Polymer | ance |
| | Separator | [s/100 mL] | [mPa · S] | Solution | Rate |
| Example 5 | Fibrillated | 1.77 | 30 | A2 | 94% |
| | Cellulose | | | | |
| Example 2 | Fibrillated | 5.48 | | | 93% |
| | Cellulose | | | | |
| Compar- | Fibrillated | 5.76 | | | 72% |
| ative | | | | | |
| Example 3 | Cellulose | | | | |

As illustrated in FIG. 4, the wound body 1 of the examples 2 and 4 and the comparative example 3 was immersed in the conductive polymer solution, so that the height of the liquid surface of the conductive polymer solution was at the upper end A2 of a connection portion illustrated in FIG. 3 and the conductive polymer was attached to wound body 1 the height of the upper end A2 of the connection portion. However, in the comparative example 3 using the separator with air permeability of 5.76 [s/100 mL], the capacity appearance rate became worse.

By this, it was observed that, when the air permeability of the separator was 5.5 [s/100 mL] or less, including the range of the examples 1 to 5, and when the immersion liquid surface height of the conductive polymer solution was at least at the round bar half position A3 or higher and the conductive polymer was attached to at least at the round bar half position A3 or higher, the capacity appearance rate of the solid electrolytic capacitor became excellent.

### Examples 6 to 8

Next, the solid electrolytic capacitors of the examples 6 to 8 were produced. In the examples 6 to 8, the viscosity of the conductive polymer solution was different. The height of the liquid surface when the wound body 1 was immersed in the conductive polymer solution and the air permeability of the separator were the same. The wound body 1 was immersed in the conductive polymer solution, so that the height of the liquid surface of the conductive polymer solution was at the upper end A2 of a connection portion illustrated in FIG. 3 and the conductive polymer was attached to the wound body 1 to the height of the upper end A2 of the connection portion. A fibrillated cellulose separator with air permeability of 5.48 [s/100 mL] was used. For the other points, the solid electrolytic capacitors of the examples 6 to 8 were produced with the same configuration, the same manufacturing method, and the same manufacturing condition as the example 2.

### Capacity Appearance Rate

The viscosity of the conductive polymer solution and the capacity appearance rate of solid electrolytic capacitor of the examples 2 and 6 to 8 are shown in the below table 5.

TABLE 5

| | | | Viscosity | Immersion | |
|---|---|---|---|---|---|
| | | | of | Position | |
| | | Air | Conductive | of | Capacity |
| | Type | Perme- | Polymer | Conductor | Appear- |
| | of | ability | Solution | Polymer | ance |
| | Separator | [s/100 mL] | [mPa · S] | Solution | Rate |
| Example 6 | Fibrillated | 5.48 | 13 | A2 | 95% |
| Example 2 | Cellulose | | 30 | | 93% |
| Example 7 | | | 42 | | 93% |
| Example 8 | | | 60 | | 86% |

As shown in the table 5, all of the solid electrolytic capacitors of the examples 6 to 8 had the excellent capacity appearance rate. In particular, the capacity appearance rate of the examples 2, 6, and 7 differed from that of the example 8. By this, it was observed that, the viscosity of the conductive polymer solution was preferably 60 [mPa·s] or less making the capacity appearance rate of the solid electrolytic capacitor excellent, and the viscosity of the conductive polymer solution was further preferably 45 [mPa·s] or less making the capacity appearance rate of the solid electrolytic capacitor more excellent.

### REFERENCE SIGN

1: wound body
1a: derived end surface
1b: opposite end surface
2: adhesive tape
3: lead terminal
31: lead wire
32: round bar portion
33: flat portion
34: connection portion
41: outer casing
42: scaling member
43: insertion hole
5: electrode foil

1. A manufacturing method of a solid electrolytic capacitor, comprising:
a winding process of winding anode foil on which dielectric film is formed and cathode foil facing each other to form a wound body;
a wrapping process of wrapping a hydrophobic adhesive tape around a circumferential surface of the wound body; and
a solid electrolyte formation process of attaching a conductive polymer in the wound body by immersing the wound body wrapped by the adhesive tape in conductive polymer solution, in which the conductive polymer is dispersed or dissolved,
wherein:
a lead terminal has a flat portion, a round bar portion, and a lead wire in series, the flat portion is connected to the anode foil and the cathode foil at the flat portion, the round bar portion protrudes from one end surface of the wound body, the lead wire is drawn out from one end surface of the wound body, and
in the solid electrolytic formation process, the wound body is immersed in the conductive polymer solution at least at half a height or higher of the round bar portion or 1 mm or higher from one end surface of the wound body.

2. The manufacturing method of the solid electrolytic capacitor according to claim 1, wherein in the winding process, a separator with air permeability of 5.5 [s/100 mL] or less is intervened between the anode foil and the cathode foil and wound.

3. The manufacturing method of the solid electrolytic capacitor according to claim 1, wherein the conductive polymer solution has viscosity of 10 mPa·s to 60 mPa·s.

4. The manufacturing method of the solid electrolytic capacitor according to claim 1, wherein the conductive polymer solution contains water as a solvent.

5. The manufacturing method of the solid electrolytic capacitor according to claim 1, wherein conductive polymer solution further contains a high boiling point solvent.

6. The manufacturing method of the solid electrolytic capacitor according to claim 1, further comprising an electrolytic solution impregnation process of impregnating the wound body with the electrolytic solution.

7. The manufacturing method of the solid electrolytic capacitor according to claim 1, wherein in the solid electrolyte formation process, the wound body is immersed in the conductive polymer solution to a connection portion between the round bar portion and the lead wire, or 2 mm or higher from one end surface of the wound body.

8. A solid electrolytic capacitor comprising:
a wound body which is anode foil on which dielectric film is formed and cathode foil facing each other and wound;
an adhesive tape which is hydrophobic and wrapped around a circumferential surface of the wound body;
a lead terminal having a flat portion, a round bar portion, and a lead wire in series, the flat portion connected to the anode foil and the cathode foil, the round bar portion protruding from one end surface of the wound body, and the lead wire drawn out from one end surface of the wound body; and
a conductive polymer attached to at least half at a height or higher of the round bar portion or 1 mm or higher from one end surface of the wound body.

9. The solid electrolytic capacitor according to claim 8, wherein the wound body includes a separator with air permeability of 5.5 [s/100 mL] or less intervening between the anode foil and the cathode foil.

10. The solid electrolytic capacitor according to claim 8, further comprising electrolytic solution impregnated in the wound body.

11. The solid electrolytic capacitor according to claim 8, the conductive polymer is attached to a connection portion between the round bar portion and the lead wire, or 2 mm or higher from one end surface of the wound body.

12. The manufacturing method of the solid electrolytic capacitor according to claim 2, wherein the conductive polymer solution has viscosity of 10 mPa·s to 60 mPa·s.

13. The manufacturing method of the solid electrolytic capacitor according to claim 2, wherein the conductive polymer solution contains water as a solvent.

14. The manufacturing method of the solid electrolytic capacitor according to claim 2, wherein conductive polymer solution further contains a high boiling point solvent.

15. The manufacturing method of the solid electrolytic capacitor according to claim 2, further comprising an electrolytic solution impregnation process of impregnating the wound body with the electrolytic solution.

16. The manufacturing method of the solid electrolytic capacitor according to claim 2, wherein in the solid electrolyte formation process, the wound body is immersed in the conductive polymer solution to a connection portion between the round bar portion and the lead wire, or 2 mm or higher from one end surface of the wound body.

17. The solid electrolytic capacitor according to claim 9, further comprising electrolytic solution impregnated in the wound body.

18. The solid electrolytic capacitor according to claim 9, the conductive polymer is attached to a connection portion between the round bar portion and the lead wire, or 2 mm or higher from one end surface of the wound body.

19. The solid electrolytic capacitor according to claim 10, the conductive polymer is attached to a connection portion between the round bar portion and the lead wire, or 2 mm or higher from one end surface of the wound body.
